(19) United States
(12) Patent Application Publication
(10) Pub. No.: US 2012/0055791 A1
(43) Pub. Date: Mar. 8, 2012

(54) DEVICE FOR DETECTING AN ANALYTE IN A FLOWABLE SAMPLE

(75) Inventors: Lee Leonard, Sunnyvale, CA (US); Victor Simonyi, Sunnyvale, CA (US); Eric Lee, Sunnyvale, CA (US)

(73) Assignee: SENOVA SYSTEMS, INC., Sunnyvale, CA (US)

(21) Appl. No.: 13/263,067

(22) PCT Filed: Apr. 7, 2010
(86) PCT No.: PCT/US10/30273

§ 371 Date: Nov. 21, 2011

Related U.S. Application Data
(60) Provisional application No. 61/167,428, filed on Apr. 7, 2009.
(60) Provisional application No. 61/225,855, filed on Jul. 15, 2009.
(60) Provisional application No. 61/289,318, filed on Dec. 22, 2009.
(60) Provisional application No. 61/308,244, filed on Feb. 25, 2010.
(60) Provisional application No. 61/309,182, filed on Mar. 1, 2010.

(51) Int. Cl. G01N 27/30

(52) U.S. Cl. 204/433

(57) ABSTRACT

A pH sensor device for continuously measuring pH in a flowable sample, the device including a housing having a channel and cavity for capturing and directing a sample aliquot to a pH sensor. The pH sensor device may further include a porous material placed adjacent to the pH sensor to attract a sample aliquot to the pH sensor via capillary force.

### FIELD OF THE INVENTION

The present invention provides methods and devices for measuring analytes in a sample. The invention relates to the fields of chemistry, analytical chemistry, and process technology.

### BACKGROUND

Electrochemical methods have long been used to measure the concentration of analytes in a sample, with hydrogen ion being a critical target analyte for a diverse array of industrial and research and development applications. Those applications include monitoring chemical and biological processes, bioreactor processes, environmental monitoring, wastewater treatment, agriculture, oil and water resource management, and many others.

Conventional pH sensors on the market today are potentiometric devices that utilize an ion sensitive glass bulb as the hydrogen ion electrode and an internal reference electrode, which is typically a Ag/AgCl wire immersed in KCl gel or liquid and separated from the sample being analyzed via a frit. These sensors measure hydrogen ion indirectly via release of ions associated with the internal surface of the glass bulb in response to hydrogen ion interaction with the external surface of the glass bulb. Such sensors are inherently problematic, and they are expensive to produce and extremely fragile, making them prone to breakage and rendering them unsuitable for applications requiring pH measurement under conditions of high temperature and/or pressure. In addition, the conventional pH sensor requires periodic calibration to maintain a constant response. Calibration requires a skilled technician and external reagents, resulting in increased cost of operation and substantial downtime.

A remarkable advance in pH technology is the solid state voltammetric internally calibrated pH sensor comprised of at least one redox-active pH sensitive material. See PCT Patent Publication Nos. 2005/066618, 2005/085825, and 2007/034131 and GB Patent Publication No. 2409902, each of which is incorporated herein by reference. The redox-active material(s) is formed into a single or multiple sensors by a number of methods. More than one pH sensitive material may be used to improve the accuracy of the measurement.

Systems employing such sensors measure pH by voltammetry instead of potentiometry, allowing for direct measurement of hydrogen ion via a redox mediated reaction with the pH sensitive material. In this type of pH meter, the sensor is exposed to a sample of interest, a voltage sweep is applied, and the resultant current peak is measured for each of the pH-sensitive materials. The potential of the pH sensitive peak is correlated to the pH of the sample, most often by means of an electronic processor unit.

These sensors, while representing an improvement over the conventional technology in terms of decreased manufacturing costs and a more malleable configuration, are still problematic.

For both conventional and solid-state sensor systems, there must be an electrical connection among the sensor's component electrodes in order for the sensor to function. In general, the sample itself provides an electrolytic solution which completes the sensor circuit. Therefore, applications where the sample is subject to agitation present the problem of having the sensor electrodes in contact with the sample at the moment of measurement. Moreover, in cases where continuous monitoring of pH is desirable, sample agitation presents the further problem of maintaining the sensor in constant contact with the sample.

A number of systems for mixing flowable materials such as fluids (including liquids, suspensions, and slurries) are known in the art. Such systems include those in which the material is contained within flexible containers such as bags. Such flexible containers have been used increasingly as a replacement for rigid containers in the process industry. In particular, pre-sterilized single-use flexible containers are widely deployed for bioprocessing. Measurement and control of pH of the process liquid inside flexible containers is desirable and often required, but conventional glass electrodes are prone to breakage during deployment or operation. The current invention describes the use of a solid-state sensor assembly in a flexible container that eliminates the risk associated with glass electrodes.

Mixing or agitation of the contents within the container is induced by rocking, shaking, squeezing or other means of moving the contents within the container, often producing a wave-like action. An example of such a system is the wave-type bioreactor system. GE Healthcare's WAVE Bioreactor System (GE Healthcare Bio-Sciences Corp., Piscataway, N.J.) is one example, and there are many others. This system employs a disposable bioreactor bag containing liquid media placed on top of the platform of a rocker apparatus which rocks back and forth within a range of angles preset by a user. The rocking motion causes the liquid media to periodically collect at opposite ends of the bag. Thus all internal surfaces of the flexible container are not submerged at all times. Thus continuous monitoring of pH (or the concentration of other analytes) in such systems presents the problem of keeping the sensor electrodes in constant contact with the sample.

Accordingly, there remains a need in the art for materials and methods for making accurate and robust sensors capable of continuously monitoring pH and other analytes present in process liquids being continuously mixed or agitated in flexible containers. Further, there remains a need in the art for devices and methods for flexible containers with built-in sensor electrodes that promote contact between the sensor and a representative sample of the process liquid at all times.

Flexible containers offer the advantage of compactness, since they can be stored and transported in the collapsed form, and returned to the collapsed form again after the contents are removed. Most present flexible containers are produced, optionally sterilized, packaged, and stored in the dry state until use. It is thus advantageous for flexible containers with built-in sensors to enable dry storage until use.

The present invention meets these needs.

### SUMMARY OF THE INVENTION

The present invention provides an improved pH sensor suitable for use in flexible containers (such as bags), as well as improved components useful in the pH sensor and methods for their construction and use. The present invention further provides designs for capturing and retaining liquid samples in direct contact with the sensor even if the sensor is not submerged in the process liquid at all times.

### BRIEF DESCRIPTION OF THE FIGURES

FIG. 1, in parts A and B, provides views of a sensor device in accordance with a representative embodiment of the present invention.

FIG. 2 shows, in parts A, B and C, provides detailed view of various aspects of a sensor device in accordance with the representative embodiment of the present invention shown in FIG. 1.

FIG. 3, in parts A and B, shows a sensor device with a porous material overlay for capturing and retaining a liquid sample in contact with the sensor or detecting surface of the sensor device in accordance with a representative embodiment of the present invention.

### DETAILED DESCRIPTION OF THE INVENTION

The present invention provides a solid state pH sensor device (or pH meter) that is superior to those currently known in the art. The sensors described herein provide for constant wetting of the sensor electrodes with a flowable material sample contained within a flexible container as the sample is being mixed or agitated.

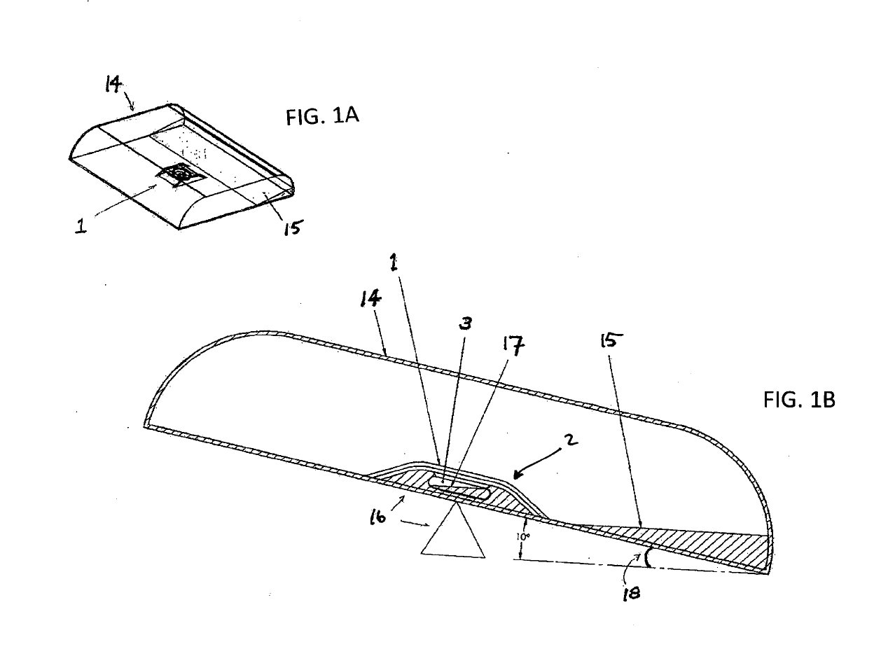

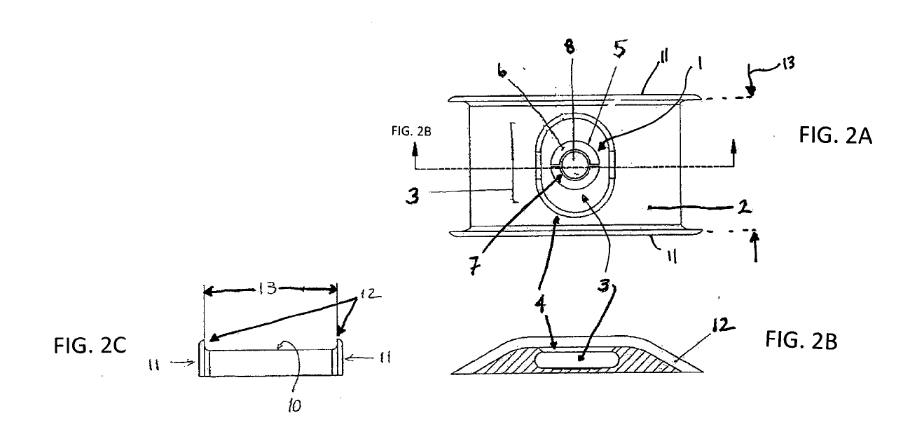

With reference to FIGS. 1A through 2A, some embodiments of the present invention comprise a pH sensor 1 having a working electrode (WE) 6, a reference electrode (RE) 7, and a counter electrode (CE) 8. In other embodiments, the sensor 1 further comprises an analyte-insensitive electrode (AIE), not shown, for internally calibrating the pH sensor.

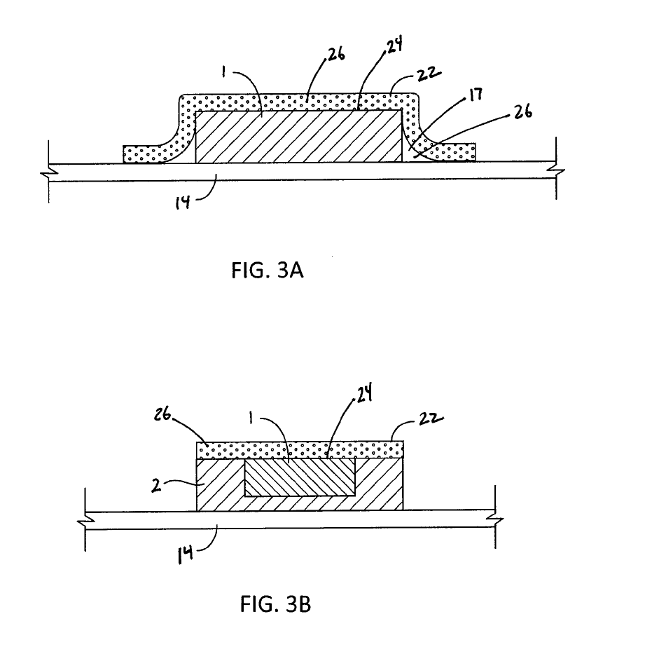

In some embodiments of the present invention, the sensor device 1 further comprises a housing 2 having a cavity 3 for capturing sample aliquots 17, as shown in FIG. 1B. In some embodiments, the pH sensor 1 is positioned within the cavity 3 such that the sample material 15 is directed into the cavity 3 via the channel 13. In other embodiments, the pH sensor 1 is disposed within a porous material 22, such that the porous material 22 covers the sensor 1 and captures or retains sample aliquots 17 on the detecting or sensor surface 24, as shown in FIGS. 3A and 3B and discussed in detail below.

### Cavity-Based Sample Capture

Referring now to FIGS. 1A through 2C, the sensor device housing 2 comprises a cavity or well 3 formed in the top surface 10 of the housing 2. The housing 2 further comprises a channel 13 for directing the sample 15 into the cavity 3.

The cavity comprises an angled lip 4 which circumscribes the top edge of the cavity 3 and is contiguous with both the top surface 10 of the housing 2 and the cavity walls. The channel 13 comprises the top surface 10 of the housing 2 in combination with channel walls or “fins” 12 formed from the side walls 11 of the channel 13. The depth and wall curvature of the cavity 13 are designed to capture a sufficiently large aliquot 17 of the sample 15 to maintain sample levels within the well 13 sufficient to keep the sensor electrodes 6, 7 and 8 wet within the range of wave system angles 18 selected by the end user.

The housing 2 can be made from any material compatible with the sample material. For example, in some embodiments the housing 2 comprises the same material as the bag 14 or flexible container. In other embodiments, housing 2 is molded from a compatible material that is different than the material of the flexible container 14. Further, in some embodiments the housing 2 is fabricated as separate molded or machined parts with embedded electrodes. The housing 2 is then fastened to the wall of the bag 14 with a sealing tool or adhesive. In other embodiments, the housing 2 is molded into the bag itself as an integral unit, wherein the electrodes are embedded afterwards or insert-molded during the molding process. Leads from the sensor electrodes exit the device on the underside of the bioreactor bag 14 and are connected to a controller/processor unit (CPU), not shown, directly or by means of cables and connectors.

In some embodiment, the sensor 1 is intended for a single use, and is disposed of along with the bag 14 at the end of a run. In other embodiments, the sensor 1 is removed from the bag 14 and reused for a separate application.

### Capillary-Based Sample Capture

With reference to FIGS. 3A and 3B, capillary-based sample capture embodiments of the present invention are shown. An alternative approach to providing continual contact between analyte liquid 15 and the sensor assembly 1 (which may comprise any combination of electrodes necessary for the intended measurement) is to utilize capillary forces to attract and hold the analyte liquid 15 against the sensor surface 24. Thus, in some embodiments, the surface 24 of the sensor assembly 1 is covered with a thin layer of openly porous material 22, where the liquid aliquot 17 is held by capillary action within the pores 26. Further, in some embodiments a space 26 is provided between the porous material 22 and the sensor assembly 1 so as to maintain contact between the sensor surface 24 and liquid aliquot 17. The term “openly porous” refers to the structure of the material 22 in which all points within the material are in fluid communication with all other points. Such materials allow hydraulic flow of fluids through its structure under local pressure gradients. In the case of liquids, such pressure gradients may be provided by agitation, rocking, stirring, inversion, and other physical movement of the body of liquid. Suitable open porous materials may be selected according to pore structure and material of construction. In some embodiments, the material 22 features pores 26 or channels small enough to hold a given analyte liquid in any position without spontaneous evacuation regardless of the position or orientation of the material, however, the pores 26 being open enough for the captured analyte liquid 15 to be renewed efficiently in response to liquid movement in its vicinity. The structure-property relationships of porous media are well established and will be readily appreciated by one having ordinary skill in the art.

In some embodiments, the openly porous material 22 is thin, thereby being limited to retain only a film of analyte liquid on the sensor surface. In other embodiments, the openly porous material 22 is selected based on its physicochemical, biological, and biochemical compatibility with the anticipated analyte liquids. Further, in some embodiments the material 22 is selected from materials of construction that facilitates secure, stable attachment to the sensor assembly.

The above construction enables capture and retention of analyte liquids at the sensor assembly once the openly porous material contacts the liquid for the first time. It provides an added benefit that contact is maintained in all positions of the flexible container, even inverted, with the sensor assembly coming into contact with the bulk liquid phase only periodically. A sensor assembly covered by the open porous material can be configured in a variety of geometric shapes, with thicknesses minimally exceeding that of the sensor assembly. Those skilled in the art will recognize that a wide variety of openly porous materials, morphologies, structures, and assembly methods will function satisfactorily in this design.

With continued reference to FIGS. 3A and 3B, in some embodiments, the porous material 22 substantially covers the active (i.e. electrochemically responsive) surface 24 of the sensor. In other embodiments, structural or non-sensing parts of the sensor are also covered by material 22. In some embodiments, the porous material 22 is in direct contact with the sensor 1 such that upon wetting of the material 22, the material 22 is bound to sensor surface 24 thereby eliminating any air gap therebetween, as shown in FIG. 3B. In some embodiments, the porous material 22 is secured by attachment to the surface of the flexible container, for example by fusing, ultrasonic welding, solvent bonding, or adhesive bonding. In other embodiments, the porous material 22 is secured to an inactive part of the sensor, for example that part which surrounds the sensing electrodes 1, such as the sensor housing 2.

### pH Sensor

pH sensors suitable for use in the pH sensor device 1 of the present invention include solid state voltammetric internally calibrated pH sensors as discussed in PCT Patent Publication Nos. 2005/066618 and 2007/034131 and GB Patent Publication No. 2409902, each of which is incorporated herein by reference.

In some embodiments of the invention, the pH sensor device of the present invention comprises a solid state pH sensor comprised of various electrodes. In some embodiments, the pH sensor is configured to include at least a working electrode (WE) comprising a redox-active analyte sensitive material. In other embodiments, the pH sensor 1 is configured to include at least a counter-electrode (CE). Further, in some embodiments, the pH sensor 1 is configured to include at least a reference electrode (RE). Still further, in some embodiments the pH sensor comprises a solid state internally calibrated pH sensor as described in U.S. Patent Application 61/161,139, filed 25 Mar. 2009, which is incorporated by reference herein.

In some embodiments, the pH sensor further comprises an analyte-insensitive electrode (AIE) for the purpose of providing a constant, pH-invariable signal peak that does not exhibit substantial drift over time. In some embodiments, the AIE comprises a redox-active analyte insensitive material that is chemically isolated from, but in electrical contact with the sample 15. Analyte-insensitive electrodes suitable for such use are described in PCT Application Nos. PCT/US10/26842 and PCT/US 10/28726, each of which is incorporated herein by reference.

In operation, the pH sensor electrodes are connected, directly or via leads, to a controller/processor unit (CPU) for delivering electrical signals to the sample aliquot and detecting the electrical responses of the sensor electrodes.

In other aspects, the pH sensor device 1 of the present invention comprises an optical sensor. Such sensors are known in the art, for example the optical pH sensor sold under the trademark TruFluor™ (Finesse Solutions, Santa Clara, Calif.), which employs a photodiode sensor, and fiber optic pH sensors such as those marketed by Ocean Optics, Dunedin, Fla., U.S.A. One having skill in the art will appreciate that other optical sensors may also be incorporated for use in the present invention. In other embodiments, the sensor device 1 of the present invention comprises a sensor capable of measuring an additional analyte, such as to determine oxygen content of the sample 17. Non-limiting examples of compatible analyte sensors include the fiber optic O₂ sensors marketed by Ocean Optics, as well as other sensors known in the art. Further, the present invention has application in all areas involving voltammetric sensing, including but not limited to the detection of metal ions, metal complexes and derivatives, e.g. As(III), Pb(II), Fe(II/III), Cu(II/I), Hg(II), and many others; detection of dissolved gases in aqueous media (e.g., O₂, CO₂, CO, SO₂, and H₂S in particular), monitoring conditions during bioreactor production; and medical and (bio)pharmaceutical Q&A, and diagnostics/accreditation.

The pH sensor device of the present invention is suitable for use in a wide variety of flexible containers and related mixing systems. In some embodiments, the device is suitable for use in flexible bags designed for use in bioreactor systems. A number of such systems are known in the art, for example the bioreactor bag sold under the trademark Biostat™ CultiBag by Sartorius-Stedim Biotech, Aubagne, France, and the bioreactor bag sold under the trademark BioProcess Container™ by Hyclone Cell Culture and Bioprocessing, Logan, Utah, U.S.A. In other embodiments, the device is suitable for use in flexible bags useful in fluid mixing systems. Examples include the flexible bag products sold under the trademarks Flexboy™ and Flexel 3D™ by Sartorius-Stedim Biotech, Aubagne, France. Many other flexible bag containers are known in the art.

Accordingly, one of skill in the art will recognize that the devices and methods of the present invention are illustrated, but not limited, by the examples that follow.

### EXAMPLES

### Cavity-Based Sample Capture Device 1

A representative embodiment of the housing component of the present invention was first modeled using 3D CAD modeling software (Dassault Systèmes SolidWorks Corp, Concord, Mass., U.S.A.) in the configuration shown schematically in FIGS. 2A-C as described above, and then fabricated in epoxy material as an SLA part. (Fine Line Prototyping, Valley, N.C., U.S.A.).

To demonstrate capture and retention of sample aliquots in the sensor well (illustrated schematically in FIG. 1B), the housing 2 was placed at the bottom center of a flexible container 14 (in this case, a bioreactor bag sold under the trademark Biostat™ CultiBag by Sartorius-Stedim Biotech, Aubagne, France) which contained a fluid sample 15 as shown in FIG. 1B. The bag was then placed on the platform of a rocker apparatus 16 such that the channel direction was parallel to the direction of sample motion. The rocker platform angle setting 18 was set at a 10 degree maximum angle. As fluid washed over the housing, an aliquot of the fluid sample 17 was captured in the sensor well 3. With each sequential rocking movement, a new wave of fluid washed over the assembly, mixing with the sample aliquot already in the well and thereby continuously replacing the existing sample aliquot with a fresh one.

### Cavity-Based Sample Capture Device 2

An exemplary embodiment of the invention, as shown in schematic form in FIGS. 1A and B, and FIGS. 2A through C, is constructed using the housing described above in combination with a pH sensor comprising a working electrode (6), a reference electrode (7), a counter electrode (8) and alternatively an analyte-insensitive electrode (not shown). pH sensors suitable for use in the sensor device of the present invention are described in PCT Application No. PCT/US10/28726, and incorporated by reference herein. Exemplary embodiments of the sensor electrodes will now be described.

### Working Electrode (WE)

A WE 6 suitable for use in the device of the present invention was formed by combining 300 mg graphite (Aldrich), 1.152 g Epoxy A and 173 mg of Epoxy B (Epotek) in a mortar and pestle and mixed till homogeneous (approximately 5 to 8 min). This material was then packed into a PEEK sensor tip housing cavity ( 3/16″ by 5 mm deep) with a brass back plate connected to a copper wire that provides for the electrical connection to a CPU. The entire unit was then cured for 1 hour at 150 degrees C. in an oven. Upon removal and cooling, the surface was sanded first with 220 grit and then 1200 grit sandpaper to give a smooth, flush surface. This process provides a graphite/epoxy sensor.

Separately, NOBF4 (1.1 mol eq) (Aldrich) was dissolved in DMF (BDH) at 0 degrees C. and either 1-aminoanthraquinone (1-aminoAQ) (TCI America) or 2-aminoanthraquinone (2-aminoAQ) (Aldrich) was added (1.0 mol equivalent). The reaction was stirred at 0 degrees C. for 45 min., and then diethyl ether (5× volume equivalent relative to DMF) (BDH) was added. This afforded a pale brown precipitate (the diazonium salt of either 1-aminoAQ or 2-aminoAQ) that was collected by centrifugation, washed with diethyl ether until the washes were colorless, and then dried.

Alternatively, the diazonium salt of either 1-aminoAQ or 2-aminoAQ was formed by suspending NOBF4 (1.1 mol eq) (Aldrich) in methylene chloride (BDH) at 0 degrees C. followed by addition of either 1-aminoanthraquinone (1-aminoAQ) (TCI America) or 2-aminoanthraquinone (2-aminoAQ) (Aldrich) (1.0 mol equivalent). The brown precipitate that resulted upon stirring was collected by filtration, washed with methylene chloride, and dried. This crude product was further purified by precipitation from DMF via the addition of diethyl ether. The precipitate was then collected by centrifugation, washed with diethyl ether until the washes were colorless, and dried.

The diazonium salt of either 1-aminoAQ or 2-aminoAQ (formed by either of the above methods) was then dissolved in DMF, and the graphite/epoxy sensor from above was immersed in this solution for 3 min. Alternatively, a drop of the diazonium-containing DMF solution was applied directly to the surface of the graphite/epoxy sensor and allowed to remain in contact with the surface for a period of time (i.e., 3 minutes). The AQ derivatized graphite/epoxy sensor was then washed with DMF and water. The resulting AQ derivatized graphite/epoxy electrode was then ready for use as a WE for pH sensing.

A suitable WE for pH sensing may also be formed by mixing epoxy with graphite or multi-walled carbon nanotubes (MWCNTs) that are derivatized with the diazonium salt of either 1-aminoAQ or 2-aminoAQ. This can be done by reacting 50 mg of graphite (Aldrich) or 50 mg of multi-walled carbon nanotubes (Nanolab) with 25 mg of the diazonium salt of either 1-aminoAQ or 2-aminoAQ (prepared as described above) in a suitable solvent. Such solvents include but are not limited to DMF, acetone, acetonitrile, water, and methylene chloride. After reaction for 1 h at room temperature, the AQ derivatized carbon materials are washed with DMF, acetonitrile, and diethyl ether and allowed to dry. The derivatized carbon materials are then mixed with epoxy, packed into a suitable PEEK housing, cured, and polished as described above.

The above approaches yield electrodes having better signal intensity, higher longevity, and lower levels of leaching of the AQ compound, and are simpler and cheaper to construct than those obtained by methods that involve agglomeration or physical adsorption of AQ onto carbon substrates. The above methods are also superior to methods using the commercially available, zinc chloride stabilized diazonium salt of AQ for carbon derivatization due to the larger signal intensity, higher peak position stability, and decreased reaction time.

### Counter-Electrode (CE)

A counter-electrode 8 suitable for use in the sensor device of the present invention was formed from a ¼ inch diameter graphite rod (Alfa Aesar) that was cut to 5 mm in length. The graphite rod was glued to a brass backing plate in a close-fitting cylindrical cavity in a PEEK housing silver epoxy (McMaster Carr). The dimensions of the cavity were the same as the rod. A copper wire attached to the brass backing plate provided an electrical connection to a controller/process unit (CPU). Once the epoxy was cured, the graphite was sanded first with 220 grit and then 1200 grit sandpaper to give a smooth, flush surface. This process was used to prepare a counter-electrode suitable for use in a pH sensor of the present invention.

This embodiment of the counter-electrode is less costly to construct than conventional platinum counter-electrodes without resulting in a sacrifice of performance, and shows less surface decomposition and hence better performance than conventional stainless steel counter-electrodes.

### Reference Electrode (RE)

An RE 7 suitable for use in the sensor device of the present invention comprises a silver/silver chloride wire in an electrolytic solution, separated from the sample by a salt bridge. The salt bridge may be a rod or disc fabricated from ceramic or from porous glass such as that sold under the trademark Vykor® (Corning, Incorporated, Corning, N.Y., U.S.). Other materials suitable for use in the RE component of the present invention are known in the art.

In an alternative embodiment, the RE comprises a silver chloride coated silver wire wherein only the silver chloride coated portion is in contact with the sample. The chloridizing process consisted of connecting the silver wire as a working electrode to a potentiostat (PGStat12, Ecochemie) configured to provide 250 microamps of constant current for 30 min. in a solution of 0.1 molar hydrochloric acid (Aldrich). This provided a chloridized silver wire.

The remainder of the silver wire is isolated from the solution via an electrically insulating covering. Electrical contact between the RE and a controller/processor unit (CPU) is then made via connection through the insulated silver wire. This silver chloride coated portion of the wire can be made according to the approach previously discussed for forming a chloridized silver wire. Further alternatives include replacing chloride with either bromide or iodide. These REs function effectively in sample compositions whose chloride, bromide or iodide concentrations, respectively, are constant within a range of 10%. This RE, being a coated wire, is quite easy to fabricate and as such provides a less costly and simpler reference electrode compared to those known in the art.

### Analyte-Insensitive Electrode

In various embodiments, the pH sensor of the present invention further comprises an analyte-insensitive electrode (AIE) for the purpose of providing a constant, pH-invariable signal peak that does not exhibit substantial drift over time. AIE suitable for use in the second exemplary embodiment of the invention are described in PCT Application No. PCT/US10/26842, which is incorporated herein by reference.

AIE technology is based on an improvement of solid state internally calibrated pH sensor comprised of two redox-active pH sensitive agents (anthraquinone (AQ) and 9,10-phenanthrenequinone (PAQ)) and one pH insensitive redox agent (e.g., Ferrocene (Fc)); see PCT Patent Publication Nos. 2005/066618 and 2007/034131 and GB Patent Publication No. 2409902. In such sensors, all three redox agents may be mixed together with multiwalled carbon nanotubes (MWCNT), graphite powder and epoxy, and the resulting admixture cured and formed into solid sensors. When a voltage sweep is applied to the sensor and the resultant current measured (using square wave voltammetry, for example), one observes three peaks: one peak for each of the three redox agents.

In these solid state internally calibrated pH sensors, the pH insensitive peak (due to Fc) should ideally be constant and independent of pH or ionic species in solution and should not drift over time. The AQ and PAQ peaks should ideally vary their position on the voltage sweep in a predictable fashion depending on the pH of the solution being measured. Finally, the positions of the pH sensitive peaks, when compared to the position of the pH insensitive peak, allow the solution pH to be deduced by comparing those values to a calibration table. For this system to have the greatest accuracy and so have the greatest scope of application, the pH insensitive peak must be stable over time, and its peak position must be unaffected by varying solution compositions. Otherwise, the accuracy of the system is compromised. Unfortunately, most if not all pH insensitive redox agents appear to be affected unsuitably by different ions and exhibit significant drift or shifts in peak position. This problem is also present in other sensors that respond to analytes other than pH. The need in the art for materials and methods for making internally calibrated pH and other analyte sensors based on redox agents is addressed by AIE technology.

AIE technology arises in part from the discoveries that (i) the pH insensitive material, or more generally, the analyte insensitive material (AIM), must be maintained in a constant chemical environment, yet separated from the solution being analyzed in such a way as to maintain electrical contact with the sample being analyzed; (ii) an electrolytic layer, which can be composed of, for example and without limitation, room temperature ionic liquids (RTIL) or other ionic liquids or liquids with sufficient ionic strength, can be used to achieve the desired results when used as a salt bridge between the AIM and the sample being analyzed; and (iii) with such an electrolytic layer, an analyte sensitive material (ASM) can be used in place of or in addition to an AIM, because the ASM is converted functionally into an AIM when a suitable electrolytic layer is employed. The electrolytic layer (e.g. composed of an RTIL or other suitable material, as described herein) provides the constant chemical environment and ionic strength for the AIM (or ASM) and provides a layer that limits or eliminates direct chemical interaction with the sample being analyzed. A broad range of redox active materials can be employed in a variety of configurations in accordance with the methods and in the “analyte insensitive electrodes” (AIEs) of this invention and devices containing them.

In some embodiments of the invention, the electrolytic layer is an IL, such as a room temperature IL (RTIL), i.e. a liquid comprised entirely of ions which is liquid at temperatures below 100 degrees Celsius. In some embodiments, the RTIL is N-butyl-N-methylpyrrolidinium bis(trifluoromethanesulfonyl)imide (C4mpyrrNTf2).

In one aspect of the invention, the redox active material in the AIE is selected from the group consisting of redox-active organic molecules, redox-active polymers, metal complexes, organometallic species, metals, metal salts, or semiconductors, and undergoes one or more electron transfer processes not involving any reaction or chemical interaction with the target analyte. In some embodiments, the redox active material in the AIE is n-butyl-ferrocene. In other embodiments, the redox active material in the AIE is K4Fe(CN)6.

In some embodiments of the invention, the conductive component comprises an electrically conductive material selected from the group consisting of carbon allotropes and derivatives thereof, transition metals and derivatives thereof, post-transition metals and derivatives thereof, conductive metal alloys and derivatives thereof, silicon and derivatives thereof, conductive polymeric compounds and derivatives thereof, and semiconductor materials and derivatives thereof. In other embodiments of the invention, the conductive component further comprises a composite material comprising a binder and an electrically conductive material. In some embodiments of the invention, the electrically conductive material present in the composite material comprises graphite and/or glassy carbon, and/or multi-walled carbon nanotubes (MWCNTs) and/or single-walled carbon nanotubes (SWCNTs), and/or any combination thereof. In other embodiments of the invention, the composite material further comprises a redox active material. In one aspect, the redox active material is n-butyl-ferrocene. In other embodiments of the invention, the composite material comprises a redox-active ASM with conferred analyte insensitivity as a consequence of the AIE construct.

In some embodiments of the invention, the AIE further comprises a conductive physical barrier adjacent to the sample, for physically separating the electrolytic layer (e.g. IL phase) from the sample. In some embodiments of the invention, the conductive physical barrier is selectively impermeable to the analyte. In some embodiments of the invention, the conductive physical barrier is selectively permeable or selectively impermeable to non-analyte species in the sample. In other embodiments of the invention, the conductive physical barrier is a porous frit. In some embodiments of the invention, the conductive physical barrier is a membrane. In other embodiments of the invention, the conductive physical barrier is a film.

In some embodiments of the invention, the AIE further comprises a second electrolytic layer adjacent to the first electrolytic layer interposed between the conductive component and the first electrolytic layer and in electrical connection with the conductive component and the first electrolytic layer, and a conductive physical barrier layer interposed between the first and second electrolytic layers, for physically separating the electrolytic layers from each other, wherein, optionally, the first electrolytic layer is substantially immiscible with the second electrolytic layer and wherein further the redox active material may also be dispersed in the second electrolytic layer. In other embodiments of the invention, the second electrolytic layer is selected from the group consisting of an aqueous electrolyte solution, a gelled aqueous electrolyte solution, an electrolytic sol gel, and an organic electrolyte solution.

The present invention provides a variety of AIEs for use in the internally calibrated pH and other analyte sensors based on redox agents provided by the invention. The schematic shown in FIG. 2 provides illustrative embodiments of this aspect of the invention. In that figure, the oval dots represent the redox active material. Additional embodiments are also provided and will be apparent to one of skill in the art upon consideration of this disclosure; for example, in some embodiments, the electrolytic layer (e.g. RTIL or other material) is in a porous structure or “conductive physical barrier”, which serves to limit direct chemical interaction and enhance electronic communication between the sample test solution and the redox active material.

In some embodiments, the RTILs are selected to include attributes of very low solubility in water and very low volatility. Thus an AIE comprising an RTIL immobilized in a porous structure will assume the geometry and dimensions of that porous structure, as opposed to the indefinite shape of a liquid.

Sensors based on AIE technology do not have to be kept wet because exposure to air does not change the composition of the sensing components. Accordingly, in the present invention, a flexible container featuring an AIE can be stored in the dry state until use. These and other embodiment of the invention are provided for illustration and not limitation of the various aspects and embodiments of the invention set forth in the following claims.

1. A device for measuring an analyte in a flowable material sample contained within a container wherein the flowable material sample is being agitated within the container, the device comprising:
an analyte sensor; and
a housing comprising a top surface, a cavity formed within the housing and open to the top surface of the housing, the pH meter being disposed in the cavity, and parallel sides contiguous with the top surface of the housing and perpendicular thereto, wherein the top surface and the parallel sides together form a channel for directing a sample fluid over the top surface of the housing and into the cavity, and wherein the cavity is configured to capture and retain a sample aliquot and maintain the analyte sensor in continuous contact with the sample aliquot.

2. The device of claim 1, wherein the analyte sensor is a pH sensor.

3. The device of claim 2, wherein the pH sensor comprises at least one of a working electrode, a reference electrode, a counter electrode, and an analyte-insensitive electrode.

4. The device of claim 1, wherein the container is a flexible bag container.

5. A device for detecting an analyte in a flowable material sample contained within a container wherein the flowable material sample is being agitated within the container, the device comprising:
an analyte sensor coupled to an interior surface of the container, the analyte sensor having a detecting surface for detecting the analyte; and
a porous material interposedly positioned between the detecting surface and the flowable material sample, wherein the flowable material sample flows through a porosity of the porous material to contact the detecting surface of the analyte sensor.

6. The device of claim 4, further comprising a capillary force between the porosity of the porous material and the detecting surface of the analyte sensor, wherein the flowable material sample is attracted to the detecting surface via the capillary force.

7. The device of claim 5, wherein the analyte sensor is a pH sensor.

8. The device of claim 6, wherein the pH sensor comprises at least one of a working electrode, a reference electrode, a counter electrode, and an analyte-insensitive electrode.

9. The device of claim 5, wherein the container is a flexible bag.
